(19) United States
(12) Patent Application Publication
(10) Pub. No.: US 2005/0101566 A1
(43) Pub. Date: May 12, 2005

(54) Arthropodicidal compositions

(76) Inventors: Ian F. Burgess, Cambridge (GB); Jayne Ansell, Billingshurst (GB)

Correspondence Address: Testa Hurwitz & Thibeault;Patent Adminstrator, High Street Tower, 125 High Street, Boston, MA, 02110, US

(21) Appl. No.: 10/472,005

(22) PCT Filed: Mar. 18, 2002
(86) PCT No.: PCT/GB02/01327

(30) Foreign Application Priority Data
Mar. 16, 2001 (GB) 0106507.7

(51) Int. Cl. A01N 55/00

(52) U.S. Cl. 514/63

(57) ABSTRACT

Fluid compositions for the eradication or control of arthropods comprise a dispersion of at least one siloxane compound as an emulsion in a water continuous phase and having a dispersed particle size in the range 1 to 10 nm, preferably 10 to 50 nm. In a preferred embodiment the siloxane compound or compounds in the dispersed phase comprise from 50 to 99.9 percent by volume of one or more volatile siloxanes with the remainder one or more non-volatile siloxanes. The dispersed phase may have from 0.1 to 15 percent by volume of one or more non-volative siloxanes and from 97.1 to 95.5 percent by volume of one or more volatile siloxanes. The non-volative siloxane is preferably a linear siloxane such as dimethicone or dimethiconol and the volatile siloxane is a cyclic siloxane such as cyclopentasiloxane or cyclomethicone. Arthropods are controlled or eradicated by applying the fluid compositions to a surface which carries, or is believed to carry, arthropods. The water phase is lost leaving the siloxane compound or compounds.

This invention relates to novel compositions for controlling and eliminating arthropods and to their method of use.

Arthropods include a large number of undesirable insects and arachnids which are difficult to control without the use of compounds which are toxic to other species and have deleterious effects on the environment.

The present invention provides compositions with very low residual toxicity and which are environmentally friendly.

According to the present invention there is provided a fluid composition for the eradication or control of arthropods comprising a dispersion of at least one siloxane compound as, an emulsion in a water continuous phase and having a dispersed particle size in the range 1 to 100 nm.

The siloxane compound may be a linear siloxane, a branched siloxane, a cyclic siloxane or a silicone copolymer or a mixture of two or more of such compounds. In a preferred embodiment the siloxane particles comprise a mixture of a non-volatile and a volatile siloxane compound.

The siloxane compound or compounds are dispersed in water in a conventional manner using a rotary blade disperser or similar equipment. Where two or more siloxane compounds are involved they may be mixed before dispersion or dispersed separately and mixed as dispersions. The preferred particle size for the dispersed phase lies in the range 10 to 50 nm. Additives, such as surfactants, may be included to assist dispersion and/or the siloxane compound or compounds may carry substituents that assist dispersion such as amino groups. Odorants, colorants and preservatives may also be present in minor amounts.

Siloxane compounds of the types used in the compositions of the invention are easily obtainable from silicone manufacturers and brokers.

As representative examples of linear siloxane compounds that may be used in the invention the following non-restrictive examples include: 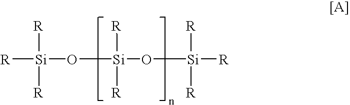
in which R represents a substituent which may be one or more linear, branched or cyclic alkyl groups containing up to 20 carbon atoms, a monocyclic or polycyclic aryl or heterocyclic group. The substituent R may carry further substituents including potentially reactive groups such as alkenyl, alkynyl, ester, ether, alkoxy, halogen, cyano and mercapto groups, primary, secondary, tertiary and quaternary amine groups and carbohydrate groups. n is an integer in the range from 1 to 1500, preferably from 20 to 7000.

Further representative examples of siloxane compounds that may be used in the compositions of the invention include: 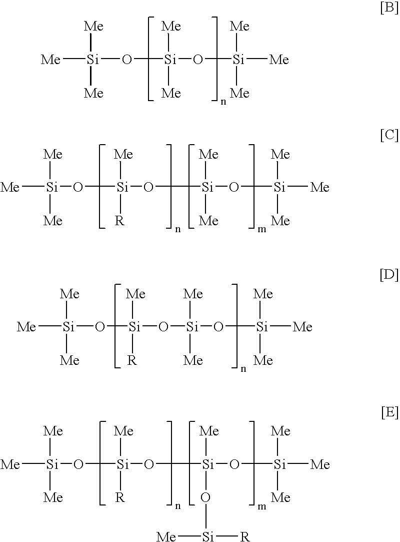
in which R represents the same substituents as described with respect to Formula [A] and in which n has the same values as in Formula A. m is an integer lying in the same ranges as for the integer n.

The volatility and viscosity of the siloxanes are dependent upon the molecular size of the compounds. This in turn depends on the numerical values of n and m defining the length of the polymeric chains and also on the nature of the substituents R. For linear siloxanes of the type illustrated by Formula B the viscosity is preferably greater than 20,000 centistokes. Examples of linear siloxanes embraced by the Formulae A to E are hexamethyldisiloxane, trimethyl end blocked polydimethyl siloxanes, phenyl trimethicone and dimethicones. Such compounds are available under the trade mark “Dow Corning” 200, 556, 2502 and 5324.

Preferred siloxane compounds shier may be eased in the compositions of the present invention are those of Formula A in which at least one of the groups R is a hydroxyl group.

As representative examples of cyclic siloxane compounds that may be used in the invention the following non-restrictive examples include: 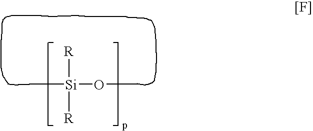
in which R represents the same substituents as described with respect to Formula [A] and in which p is an integer in the range 3 to 10. As with the linear siloxane compounds the volatility and viscosity of the cyclic siloxane compound depends upon the molecular size of the compound. This in turn depends upon the numerical value of p defining the size of the cyclic ring and also on the nature of any substituents R. For non-volatile cyclic siloxane compounds in which R is a methyl group p should be greater than 7. R is preferably not a hydrogen atom or a hydroxyl group in the preferred cyclic compounds.

The preferred cyclic siloxane compounds for use in the compositions of the invention are preferably volatile compounds in which p lies in the range 3 to 7 and R is an alkyl group having up to 10 carbon atoms, and aryl group having 6 to 10 carbon atoms, a hydrogen atom or a vinyl group. The most preferred compounds are those in which R is a methyl group and p lies in the range 4 to 6. The compounds may comprise a mixture of compounds with different values of p within the preferred range.

Examples of cyclic siloxanes embraced by the Formula F are hexamethylcyclotrisiloxane, octomethylcyclopentasiloxane and decamethylcyclohexasiloxane including mixtures thereof. Preferred cyclic siloxanes for use in the invention include cyclodimethicones such as those available under the trade marks “Dow Corning” 245, cyclopentasiloxane, and 345, a mixture of cyclopentasiloxane and cyclolhexasiloxane.

As representative examples of siloxane copolymer compounds that may be used in the invention the following non-restrictive examples include: 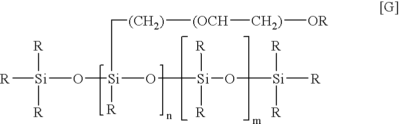
in which R represents the same substituents as described with and in which n has the same values as in Formula A and m is an integer lying in the same ranges as for the integer n. X is chosen, taking into account the values of n and m, to give a copolymer with a preferred molecular, weight in the range 1000 to 30,000 and a non-siloxane content in the range 25 to 90 percent. Such compounds have viscosities in the range 40 to 40,000 centistokes. Such compounds include dimethicone copolyol available under the trade mark “Dow Corning” 193.

Commercially available siloxanes and compounds suitable for use in the invention are available in a variety of viscosities in general governed by the chain length and hence molecular weight of the main components. “Dow Corning” 200 is available with viscosities in the range 0.65 to 60,000 centistokes. The low molecular weight compounds will be volatile while the higher molecular weight compounds will be non-volatile. For many embodiments of the invention a mixture of volatile and non-volatile siloxane compounds is preferred.

The siloxane compound in the dispersed phase of the compositions of the present invention may comprise from 50 to 99.9 percent by volume of a volatile silicone, preferably 85 to 99 percent by volume, and from 0.1 to 50 percent by volume of a non-volatile siloxane, preferably 0.1 to 15 percent by volume. A most preferred range is 97.1 to 95.5 percent by volume of a volatile siloxane with the remainder a non-volatile siloxane.

A preferred non-volatile siloxane is a linear siloxane such as dimethicone or dimethiconol. The volatile siloxane is preferably a cyclic siloxane such as cyclopentasiloxane or cyclomethicone.

The action of the cyclosiloxanes in the composition may be enhanced in some cases by the addition of small amounts of hydrocarbon oils or waxes or a dispersion of polytetra fluoroethylene particles.

The compositions of the invention are effective in the control of arthropods, particularly terrestrial arthropods, such as insects and arachnids. The compositions may easily be applied in fluid form. The water forming the continuous phase evaporates, is absorbed or is otherwise removed after application to a substrate leaving the dispersed phase in contact with the surface being treated. The particles comprising the dispersed phase may coalesce to form a film on the substrate to which they have been applied and on any arthropods with which they come, into contact. The dispersions have been found to be particularly effective against wood boring insects, fleas, lice, sweet itch mites, I bed bugs, cockroaches, ticks, weevils and house dust mites.

1. A fluid composition for the eradication or control of arthropods comprising a dispersion of at least one siloxane compound as an emulsion in a water continuous phase and having a dispersed particle size in the range 1 to 100 nm.

2. The fluid composition as claimed in claim 1 in which the dispersed particle size is in the range 10 to 50 nm.

3. The fluid composition as claimed in claim 1 or claim 2 in which the siloxane compound or compounds in the dispersed phase comprise from 50 to 99.9 percent by volume of one or more volatile siloxanes with the remainder one or more non-volatile siloxanes.

4. The fluid composition as claimed in claim 3 in which the siloxane compound or compounds in the dispersed phase comprise from 0.1 to 15 percent by volume of one or more non-volatile siloxanes.

5. The fluid composition as claimed in claim 3 in which the siloxane compound or compounds in the dispersed phase comprise from 97.1 to 95.5 percent by volume of one or more volatile siloxanes.

6. The fluid composition as claimed in any of the preceding claims 3 to 5 in which the non-volatile siloxane is a linear siloxane.

7. The fluid composition as claimed in claim 6 in which the non-volatile siloxane is dimethicone or dimethiconol.

8. The fluid composition as claimed in any of the claims 3 to 5 in which the volatile siloxane is a cyclic siloxane.

9. The fluid composition as claimed in claim 8 in which the volatile siloxane is cyclopentasiloxane or cyclomethicone.

10. The method of controlling arthropods comprising applying to a surface a fluid composition as claimed in any of the claims 1 to 9.
